(19) United States
(12) Patent Application Publication
(10) Pub. No.: US 2023/0176858 A1
(43) Pub. Date: Jun. 8, 2023

(54) PATCH IMPLEMENTATION FOR MULTI-VALUED ATTRIBUTES

(71) Applicant: SAP SE, Walldorf (DE)

(72) Inventor: ARIJIT PAL, Bengaluru (IN)

(21) Appl. No.: 17/540,515

(22) Filed: Dec. 2, 2021

(51) Int. Cl. G06F 8/65; G06F 8/61; G06F 8/41

(52) U.S. Cl. CPC G06F 8/66; G06F 8/61; G06F 8/447

(57) ABSTRACT

A method, a system, and a computer program product for executing a patch implementation to update one or more values stored by a target computing system. One or more values for updating one or more stored values are received. The stored values are associated with one or more attributes of a storage array stored in one or more databases of a computing system. The storage array and one or more attributes are retrieved from the databases. At a least a portion of the attributes requiring an update to corresponding stored values is identified. Based on the identified attributes, the update to the corresponding stored values using the one or more received values is executed. At least one first attribute in the identified attributes is excluded from the update. At least one patch file including at least one of the updated values of the identified attributes and excluded first attributes is generated and stored.

### TECHNICAL FIELD

This disclosure relates generally to data processing and, in particular, to patch implementation for multi-valued attributes, such as, for example, as part of user(s) and/or group(s) provisioning.

### BACKGROUND

Software applications provide companies with an ability to efficiently and effectively conduct their businesses. Software applications deal with various aspects of companies' businesses, including finances, product development, procurement, human resources, customer service, management, and many other aspects. During their lifecycles, software applications can undergo a multitude of updates and/or corrections. Some of these updates/corrections may be required to accommodate changing needs of the companies, updates to other software applications, changes in operating systems that companies employ, as well as for any other reasons.

### SUMMARY

In some implementations, the current subject matter relates to a computer-implemented method for executing a patch implementation to update one or more values stored by a target computing system. The method may include receiving, using at least one processor, one or more values for updating one or more stored values. The stored values may be associated with one or more attributes of a storage array stored in one or more databases of a computing system. The method may further include retrieving the storage array and one or more attributes from the databases, identifying at a least a portion of one or more attributes requiring an update to corresponding stored values, and executing, based on the identified attributes, the update to the corresponding stored values using one or more received values. The execution of the update may include excluding at least one first attribute in the identified one or more attributes from the update. The method may also include generating at least one patch file including at least one of the updated values of the identified attributes and excluded first attributes, and storing the patch file.

In some implementations, the current subject matter can include one or more of the following optional features. The update may include at least one of the following operations: an addition of a value operation, a removal of a value operation, an addition of an attribute to the storage array, a removal of an attribute from the storage array, and any combination thereof.

In some implementations, the excluded first attributes may include at least one of the following: a read-only attribute, an immutable attribute, and any combination thereof. Further, the receiving and/or any other operations may be executed using a system cross-domain identity management (SCIM) protocol. The patch file may be a java script object notation (JSON) patch file. Further, the storage array may be a multi-value storage array that may include a plurality of attributes.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary system for implementing one or more patch processes, such as, using system cross-domain identity management (SCIM) protocols, according to some implementations of the current subject matter;

FIG. 1b illustrates additional detail of the system shown in FIG. 1a, according to some implementations of the current subject matter;

FIG. 2 illustrates an exemplary patch implementation process, according to some implementations of the current subject matter;

FIGS. 3a-h illustrate examples of attribute add and remove operations that may be performed by a transformer of system shown in FIGS. 1a-b, according to some implementations of the current subject matter;

FIG. 4 is an exemplary system, according to some implementations of the current subject matter; and

FIG. 5 is an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for patch implementation as part of software maintenance.

Various computing landscapes, e.g., procurement landscapes, etc., make use of system cross-domain identity management (SCIM) protocols for user and group provisioning. SCIM refers to a standard for automating exchanges of user identity information between identity domains, and/or information technology (IT) systems. SCIM protocols can be used, for example, in adding new employees to company IT directories. For instance, a company may on-boards one new employee and separate another employee from its personnel. In the first instance, the employee is added and in the second instance, they are removed from the company's electronic employee directory. SCIM can be used to automatically add/delete (provision/de-provision) accounts for those users in external systems. Upon creation, a new user account will exist in the external systems for each new employee, and user accounts for past employees may no longer exist in such systems. SCIM is also used to share various information, such as, user attributes, attribute schema, group membership, etc. Attributes can include, for example, user contact information, group membership, etc. Group membership or other attribute values can be used to manage user permissions. Attribute values and/or group assignments can change, which may make it challenging to maintain relevant data across multiple identity domains. SCIM typically uses a standardized application programming interface (API) through representational state transfer (REST) protocol, where data can be formatted in JSON and/or XML.

As stated above, some computing (e.g., procurement) landscape may also require use of SCIM protocol for users and groups provisioning. Services involved in such user/group provisioning may use one or more of the following functions: POST, PUT, PATCH, DELETE, GET. Further, SCIM PATCH may be an optional server function that may enable users/clients to update one or more attributes of a SCIM resource users/groups using a sequence of operations to “add”, “remove”, “replace”, etc. values.

SCIM PATCH may be executed by comparing a JSON array structure of the resource users/groups with that of a payload of data packet requesting changes to make any necessary modifications to users/groups. In particular, the SCIM PATCH process (as defined in RFC 7644 Sec. 3.5.2) is based on a JSON PATCH (as defined in RFC 6902), with the exception of support for array indexing, because servers executing the SCIM processes do not guarantee an order of contents of a multi-valued array that may be retrieved for users/groups resources, and hence, indexes cannot be used. Thus, SCIM PATCH modifications for single-valued attributes may be executed using the JSON PATCH, which cannot handle multi-valued attributes.

The following is an example of an ADD operation in the JSON PATCH for multi-valued attributes using array indexes. In this example, “employees” corresponds to the multi-valued attribute, and {“name”: “John Smith”} can be sub-attribute.

{“op”: “add”, “path”: “/Employees/1”, “value”: {“name”: “John Smith”}}

The following is an example of ADD operation using SCIM PATCH. In this example, “emails” refers to the multi-valued attribute, and {value”: “John.Smith@Home.com”, “primary”: false, “type”: “ ”} can refer to the sub-attribute. Since order is not guaranteed by the servers executing SCIM processes for the contents in multi-valued array, indexes in a file path, such as, “/Employees/1”, cannot be used in SCIM PATCH operations. Instead, the SCIM PATCH process may need to use the following code for execution:

```
{
  “schemas”: [
    “urn:ietf:params:scim:api:messages:2.0:PatchOp”
  ],
  “Operations”: [
    {
      “op”: “add”,
      “path”: “emails ”,
      “value”: [
        {
        “value”: “John.Smith@Home.com”,
        “primary”: false,
        “type”:”“”
        }
      ]
    }
```

However, in various computing landscapes (e.g., procurement landscape), users/groups resources may have different multi-valued attributes, such as Telephone, Emails, Multi-Lingual String representation of User names, and others. However, the current computing landscapes are not capable of processing use of multi-valued attributes. In some implementations, the current subject matter may be configured to process multi-valued attributes by executing limitations in modifications read only and/or immutable attributes.

Additionally, the current subject matter may also apply limitations when multiple sub-attributes are specified in the PATCH resource, as illustrated below.

```
{
  “schemas”: [
    “urn:ietf:params:scim:api:messages:2.0:PatchOp”
  ],
  “Operations”: [
    {
      “op”: “add”,
      “path”: “emails ”,
      “value”: [
        {
          “value”: “John.Smith@Office.com”,
          “primary”: true,
          “type”:
        },
        {
          “value”: “John.Smith@Home.com”,
          “primary”: false,
          “type”:
        }
      ]
    }
  ]
}
```

Further, in some implementations, the current subject matter may be configured to apply limitations in the ADD operation, where a target location may specify a multi-valued attribute. Moreover, the current subject matter may be configured to apply a limitation in REMOVE operation, where a target location may specify a multi-valued attribute.

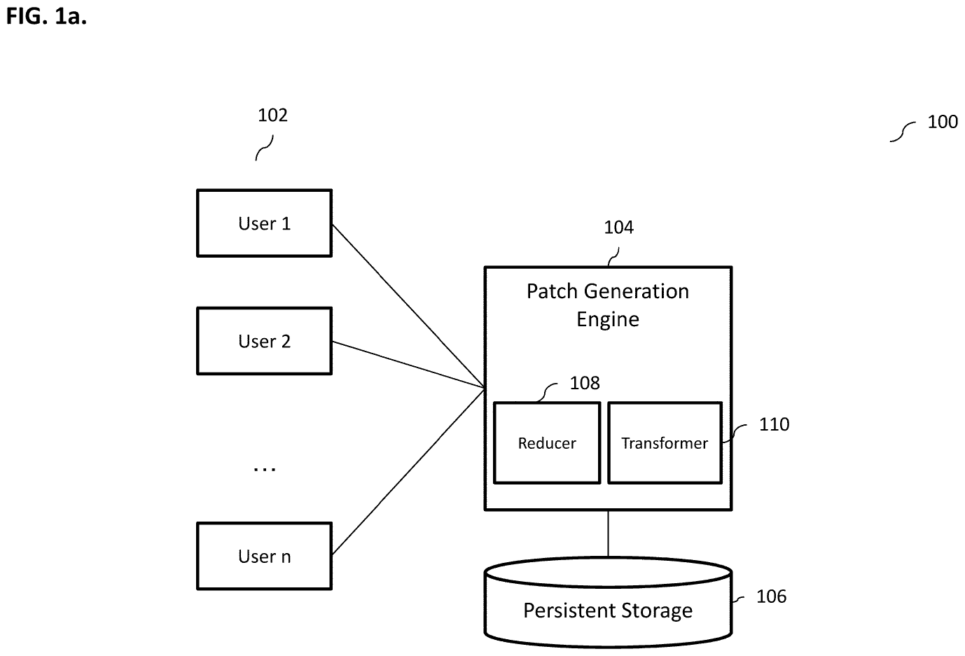

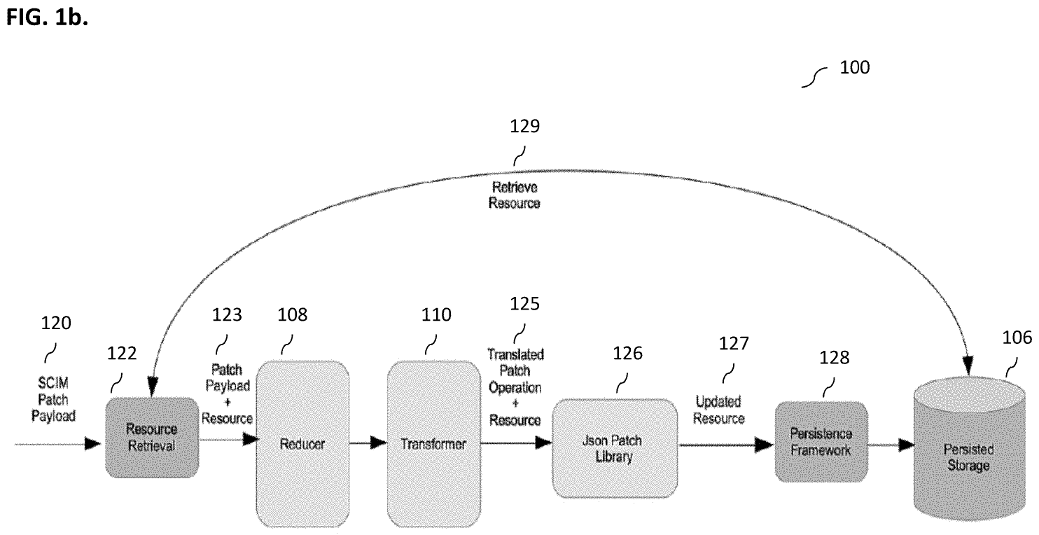

FIG. 1a illustrates an exemplary system 100 for implementing one or more patch processes, such as, using system cross-domain identity management (SCIM) protocols, according to some implementations of the current subject matter. The system 100 may be configured to operate in one or more clustered computing environments, one or more cloud environments, etc. It may include one or more users, entities, applications, etc. 102 (e.g., user 1, user 2, . . . , user n, etc.), a patch generation engine 104, and a persistent storage database 106. The engine 104 may include one or more computing elements, which may, for example, as discussed below, include one or more processors, one or more servers, one or more computing engines, one or more memory and/or storage locations, one or more databases, etc. The patch generation engine 104 may be configured to execute a patch generation process, which may use one or more reducer components 108 and/or one or more transformer component 110, where the patch generation processes may be executed based on one or more patch payload data (e.g., SCIM patch payload data) that may be provided to it by one or more users 102 as input and, as a result of its internal processing, may output patches.

The engine 104 may include a processor, a memory, and/or any combination of hardware/software, and may be configured to allow one or more users 102 to communicate with the patch generation engine 104 to perform one or more tasks associated with patch generation, as will be discussed below. The tasks may be configured to rely on data, functions and/or features (and/or any combination thereof) of one or more computing components (e.g., components 108, 110) such that the task is an integration and/or a combination of one or more computing components. The computing components of the engine 104 may refer to a software code that may be configured to perform a particular function, a piece and/or a set of data (e.g., publishing data unique to a particular user 102 and/or data available to a plurality of users) and/or configuration data used to create, modify, etc. one or more software functionalities associated with a particular task, sub-task, and/or a portion of a patch generation process.

The elements of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Moreover, the elements of the system 100 may include any combination of hardware and/or software. In some implementations, the elements may be disposed on one or more computing devices, such as, server(s), database(s), personal computer(s), laptop(s), cellular telephone(s), smartphone(s), tablet computer(s), and/or any other computing devices and/or any combination thereof. In some implementations, the elements may be disposed on a single computing device and/or can be part of a single communications network. Alternatively, the elements may be separately located from one another.

FIG. 1b illustrates additional detail of the system 100 shown in FIG. 1a. In particular, FIG. 1b illustrates various components that the patch generation engine 104 may include and implement for the purposes of patch generation. As shown, the engine 104 may be configured to include one or more components and/or layers that may be positioned (or written) on top of any JSON patch layer in the engine 104. The engine 104 may be configured to translate patch resource operation from receiving of a payload to JSON patch resource operation.

To perform the above translation, the engine 104 may be configured to receive a patch payload 120 (e.g., data related to adding of new employees, etc.), the engine 104 may then use a resource retrieval component 122 to determine and/or obtain required resources that may be needed for generation of patches. The information about requisite resource along with the patch payload may be supplied, at 123, to the reducer component 108.

The reducer component 108 may be configured to maintain a read-only and/or immutability status of a specific attribute related to the data (e.g., employee's name). The read-only and/or immutable attributes may be custom-defined and maintained in an appropriate property file/storage location that may be accessed to determine status of a particular attribute and its corresponding characteristics. By way of a non-limiting example, in some computing environments or landscapes (e.g., a procurement computing environment or landscape), there may exist certain attributes that may be considered unique, and thus, should not and/or must not be overwritten. Overwriting these attributes, would cause data corruption. Reducer layer removes these attributes from the JSON resource, before it can be updated. Examples of read-only attributes for a user resource may include, but are not limited to, username, groups, meta. Examples of read-only attributes for a group resource may include, but are not limited to, displayName, meta.

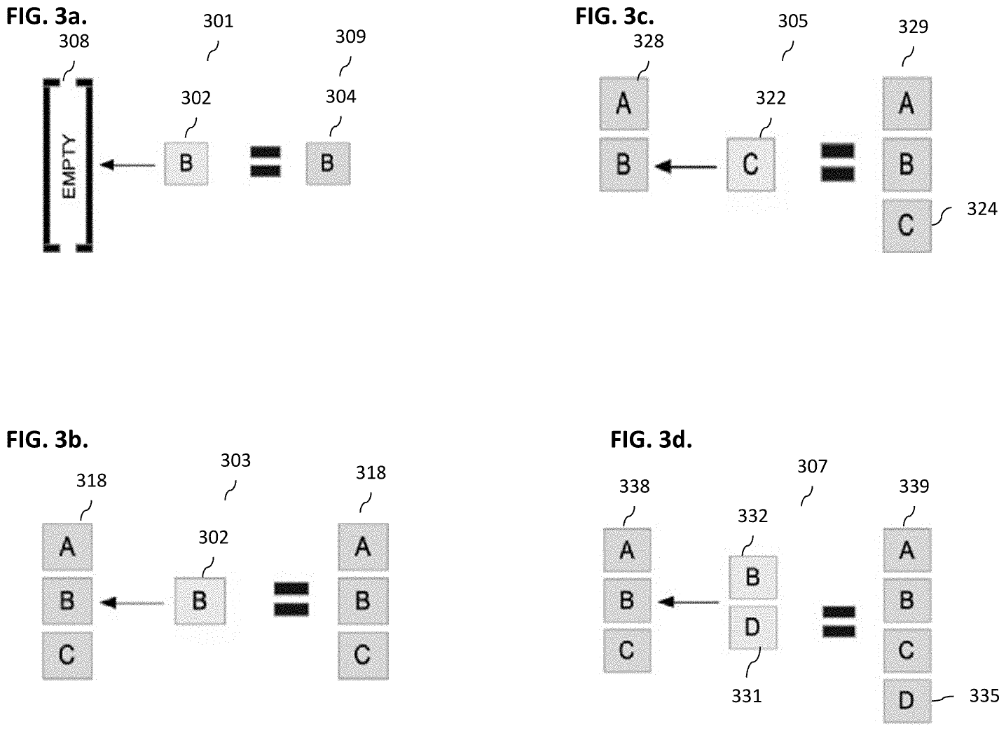

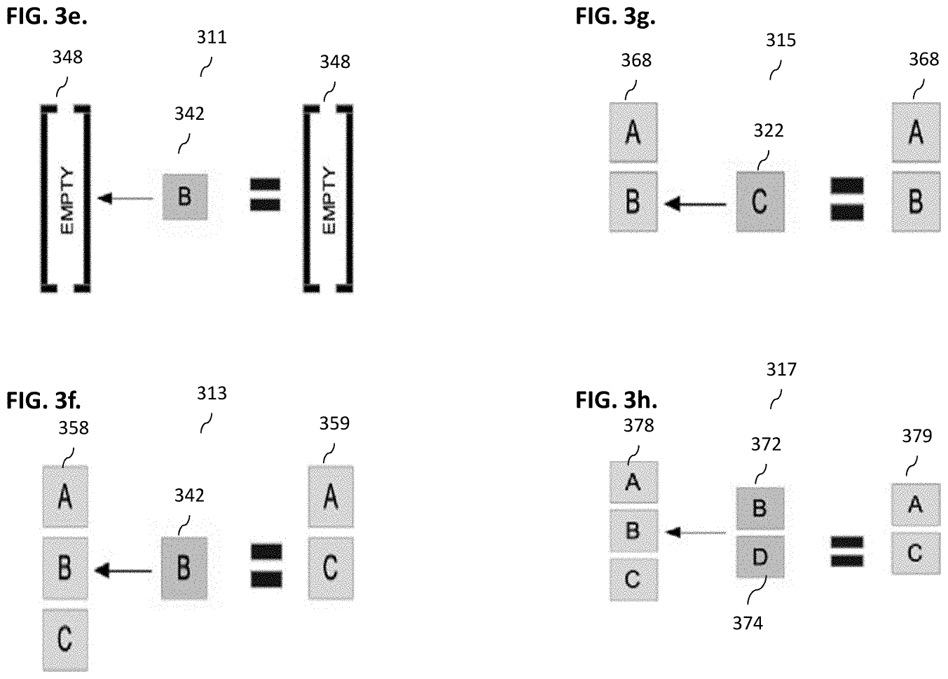

Once the reducer 108 identified read-only and/or immutable attributes in the provided patch payload data, the engine 104 may be configured to provide the patch data to the transformer 110. The transformer 110 may be configured to process the received data and perform an ADD operation (e.g., to add various attributes, data, etc.), a REMOVE operation (e.g., to remove various attributes, data, etc.), and/or any other operations. Execution of these operations may be applicable to attributes, data that is not read-only and/or immutable attributes. FIGS. 3a-h illustrate examples of attribute add and remove operations that may be performed by the transformer 110. In particular, FIGS. 3a-d illustrate attribute add operations and FIGS. 3e-h illustrate attribute remove operations.

In some implementations, in the ADD operation, where a target location (e.g., a system and/or a process where patching is to be applied) specifies a multi valued attribute, the transformer 110 may be configured to specify a sub-attribute to be added in the PATCH payload. The following exemplary code may be used for specifying the sub-attribute “path”: “emails”:

```
{
  “schemas”: [
    “urn:ietf:params:scim:api:messages:2.0:PatchOp ″
  ],
  “Operations”: [
    {
      “op”: “add”,
      “path”: “emails ”,
      “value”: [
        {
          “value”: “email-to-add@test.com”,
          “primary”: true,
          “type”: “”
        }
      ]
    }
  ]
}
```

FIG. 3a illustrates an exemplary add operation 301 that may be performed by the transformer 110, according to some implementations of the current subject matter. The add operation 301 may be performed to add an attribute “B” 302 that may be specified in the patch payload 120 (as shown in FIG. 1b) to a target location system that may specify a multi-valued attribute structure (i.e., target location array 308). Assuming the attribute-to-be added is not a read-only and/or immutable, the transformer 110 may be configured to add attribute “B” 302 to the target location array 308, which may be currently empty. Upon addition, a new sub-attribute 304 may be included in the updated multi-valued attribute array 309.

FIG. 3b illustrates another exemplary add operation 303 that may be performed by the transformer 110, according to some implementations of the current subject matter. The add operation 303 may be performed to add an attribute “B” 302 that may be specified in the patch payload 120 (as shown in FIG. 1b) to a target location array 318 that may again specify a multi-valued attribute array structure. Assuming the attribute-to-be added is not a read-only and/or immutable, the transformer 110 may be configured to add attribute “B” 302 to the target location array 318, however, in this case, the target location 318 is not empty, and instead already includes attribute “B” (as shown on the left side of FIG. 3b). Thus, a request to add attribute “B” 302 may be ignored. Thus, the array 318 may remain unchanged.

FIG. 3c illustrates another exemplary add operation 305 that may be performed by the transformer 110, according to some implementations of the current subject matter. The add operation 305 may be performed to add an attribute “C” 322 that may be specified in the patch payload 120 (as shown in FIG. 1b) to a target location array 328 that may have a multi-valued attribute structure and that may be non-empty (in contrast to FIG. 3a), i.e., include attributes “A” and “B” (as shown by the left side of the FIG. 3c). Again, assuming the attribute-to-be added is not a read-only and/or immutable, the transformer 110 may be configured to add attribute “C” 322 to the target location array 328. In this case, the engine 104 may check that the target location 328 is not only not empty but also does not include the attribute “C”. Thus, a request to add attribute “C” 322 may cause a new sub-attribute “C” 324 to be included in the multi-valued attribute array 329 (i.e., “A”, “B”, “C”).

In case the target location multi-valued attribute array is non-empty, and the SCIM patch resource 122 specifies that it may include multiple sub-attributes, addition and/or non-addition of sub-attributes in the SCIM patch resource may depend on whether one or more sub-attributes to be added is and/or is not available in the target multi-valued attribute array. FIG. 3d illustrates another exemplary add operation 307 that may be performed by the transformer 110, according to some implementations of the current subject matter. The add operation 307 may be performed to add attributes “B” 332 and “D” 331 that may be specified in the patch payload 120 (as shown in FIG. 1b) to a target location multi-valued attribute array 338, which includes attributes “A”, “B”, and “C”. Again, assuming the attributes-to-be added are not read-only and/or immutable, the transformer 110 may be configured to add attribute “B” 332 and “D” 331 to the target location array 338. However, attribute “B” already exists in the array 338 (as shown on the left side of FIG. 3d) and thus, its addition may be ignored. Thus, only attribute “D” 331 may be added by the transformer to the array 338, thereby generating the multi-valued attribute array 339 (i.e., “A”, “B”, “C”, “D”) at the target location, which now includes attribute “D” 335.

In some implementations, in the REMOVE operation, where a target location (e.g., a system and/or a process where patching is to be applied) specifies a multi-valued attribute, the transformer 110 may be configured to specify a sub-attribute to be removed as identified in the PATCH payload. The following exemplary code may be used for specifying the sub-attribute “path”: “emails”:

```
{
  “schemas”: [
    “urn:ietf:params:scim:api:messages:2.0:PatchOp”
  ],
  “Operations”: [
    {
      “op”: “remove”,
      “path”: “emails ”,
      “value”: [
        {
          “value”: “email-to-remove@test.com
          “primary”: true,
          “type”: “”
        }
      ]
    }
  ]
}
```

FIG. 3e illustrates an exemplary remove operation 311 that may be performed by the transformer 110, according to some implementations of the current subject matter. The remove operation 311 may be performed to remove an attribute “B” 342 that may be specified in the patch payload 120 (as shown in FIG. 1b) from a target location array 348 that may specify a multi-valued attribute structure. Assuming the attribute-to-be removed is not a read-only and/or immutable, the transformer 110 may be configured to remove attribute “B” 342 from the target location array 348, however, as shown in FIG. 3e, the target location array 348 may be currently empty. As such, removal of the attribute “B” 342 may be ignored, thereby leaving the target location array 348 unchanged, i.e., empty.

FIG. 3f illustrates another exemplary attribute removal operation 313 that may be performed by the transformer 110, according to some implementations of the current subject matter. The remove operation 313 may be performed to remove an attribute “B” 342 that may be specified for removal (e.g., removal of a past employee's email) in the patch payload 120 (as shown in FIG. 1b) from a target location array 358 that may have a multi-valued attribute array structure. Assuming the attribute-to-be removed is not a read-only and/or immutable, the transformer 110 may be configured to remove attribute “B” 342 from the target location array 358. Since target location array 358 already includes attribute “B”, the remove operation removes this attribute, thereby generating a resulting array 359 (containing attributes “A”, “C”) at the target location.

FIG. 3g illustrates another exemplary remove operation 315 that may be performed by the transformer 110, according to some implementations of the current subject matter. The remove operation 315 may be performed to remove an attribute “C” 362 that may be specified in the patch payload 120 (as shown in FIG. 1b) from a target location array 368 that may specify a multi-valued attribute structure and that may be non-empty. Again, assuming the attribute-to-be removed is not a read-only and/or immutable, the transformer 110 may be configured to remove attribute “C” 322 from the target location array 368. However, in this case, the array 368, even though is not empty, does not include attribute “C”. As such, operation may be ignored, thereby leaving the array 368 unchanged, i.e., containing only attributes “A” and “B”.

In case the target location multi-valued attribute array is non-empty, and the SCIM patch resource 122 specifies that it may include multiple sub-attributes, removal and/or non-removal of sub-attributes in the SCIM patch resource may depend on whether one or more sub-attributes to be removed is and/or is not available in the target multi-valued attribute array. FIG. 3h illustrates another exemplary remove operation 317 that may be performed by the transformer 110, according to some implementations of the current subject matter. The remove operation 317 may be performed to remove attributes “B” 372 and “D” 374 that may be specified in the patch payload 120 (as shown in FIG. 1b) from a target location array 378. Here, the array 378 may indicate that attributes “A”, “B” and “C” already exist at the target location. If the attributes-to-be removed are not read-only and/or immutable, the transformer 110 may be configured to remove attribute “B” 372 and “D” 374 from the target location array 378. However, attribute “D” does exist in the array 378 and hence, cannot be removed from the array 378, as such, its removal may be ignored. Hence, only attribute “B” 372 may be removed by the transformer 110 from the array 378 to generate the multi-valued attribute array 379 at the target location (i.e., “A”, “C”).

Referring back to FIG. 1b, upon the reducer 108 and transformer 110 have performed their operations (e.g., exclusion of read-only/immutable attributes from add/remove operations, and performing add/remove operations on other attributes, as appropriate), the data related to translated patch operations and resources may be transmitted, at 125, to the JSON patch library 126. The JSON patch library 126 may be configured to execute and/or otherwise, obtain appropriate JSON patches corresponding to the received data and provide patches, including any updated resources, at 127 to a persistence framework 128, which may store the updated sources/patches in the persisted storage database 106. The persisted storage database 106 may provide resources (e.g., upon request/query), at 129, to the resource retrieval component 122 when a specific patch operation payload is received.

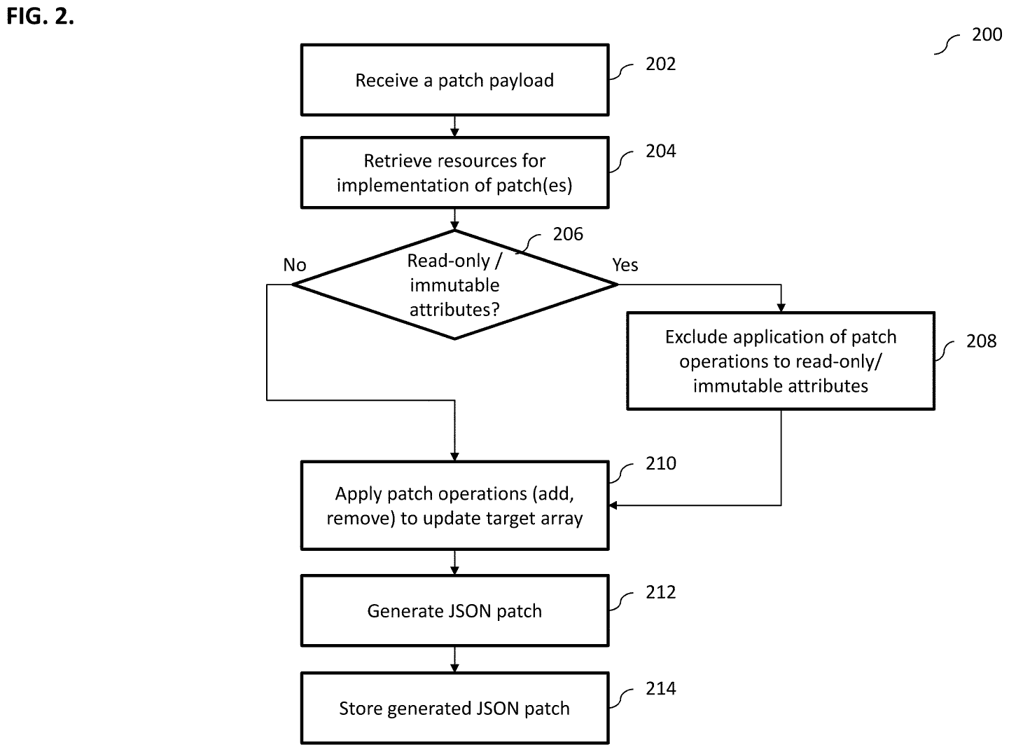

FIG. 2 illustrates an exemplary patch implementation process 200, according to some implementations of the current subject matter. The process 200 may be configured to be performed using the system 100 and one or more of its components as shown in FIGS. 1a-b. At 202, a patch payload may be received by the system 100 (shown in FIG. 1). The payload may include one or more values corresponding to one or more attributes that may be included in one or more attribute arrays (e.g., target arrays 308, 318, 328, etc. shown in FIGS. 3a-h) stored at a target system, where an update of values may be needed. The patch payload may be received from one or more users 102, such as, via a query to update values (e.g., add data related to new employees, remove data related to past employees).

At 204, the engine 104 may be configured to query the persistent storage database 106 to determine the resources that may be associated with the requested patch update. The resources may include specific attribute arrays stored by the target system. The engine 104 may then supply the received patch data and the resource information to reducer component 108 and transformer component 110 for determining how to apply specific updates included in the patch payload.

At 206, the reducer component 108 may be configured to determine whether the patch payload includes updated values for one or more read-only and/or immutable attributes. Such attributes are associated with data values that cannot be changed and/or altered in any way. If that is the case, any updates (addition, removal, etc. of values corresponding to the read-only/immutable attributes) to values that may be contained in the patch payload may be excluded from any subsequent patch operations, at 208. Once the attributes have been excluded, the processing may proceed to 210. If there are no read only/immutable attributes, the process 200 may also proceed to 210.

At 210, the updates to values specified in the patch payload as associated with the retrieved resources may be applied to the data values stored at the target system. The data values may be added, removed, etc. to update the attribute array values stored by the target system, where update is desired. Examples of add and/or remove operations are shown in FIGS. 3a-h.

At 212, a JavaScript Object Notation (JSON) patch may be generated based on the addition and/or removal operations specified, at 210. The JSON patch may then be applied to the data and stored at the persistent storage database 106, at 214. As stated above, the database 106 may be used to provide appropriate resources for execution of future patch updates.

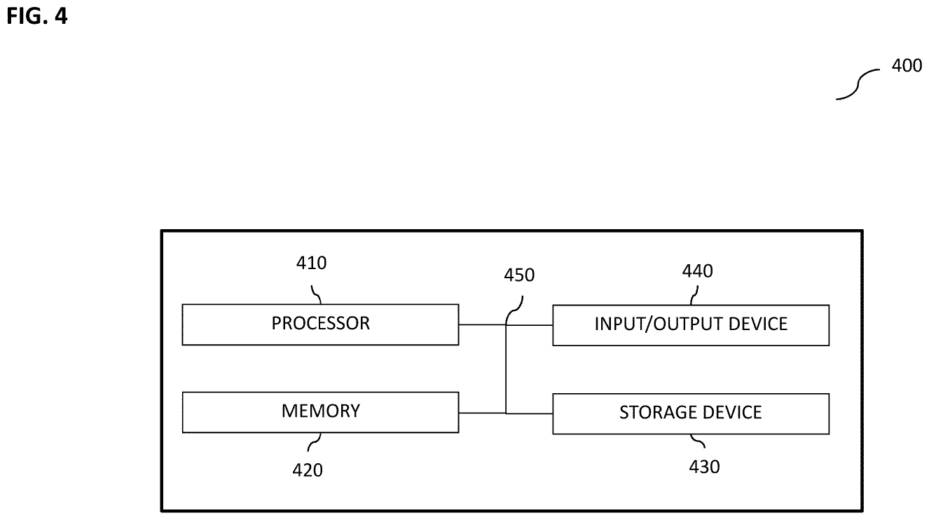

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

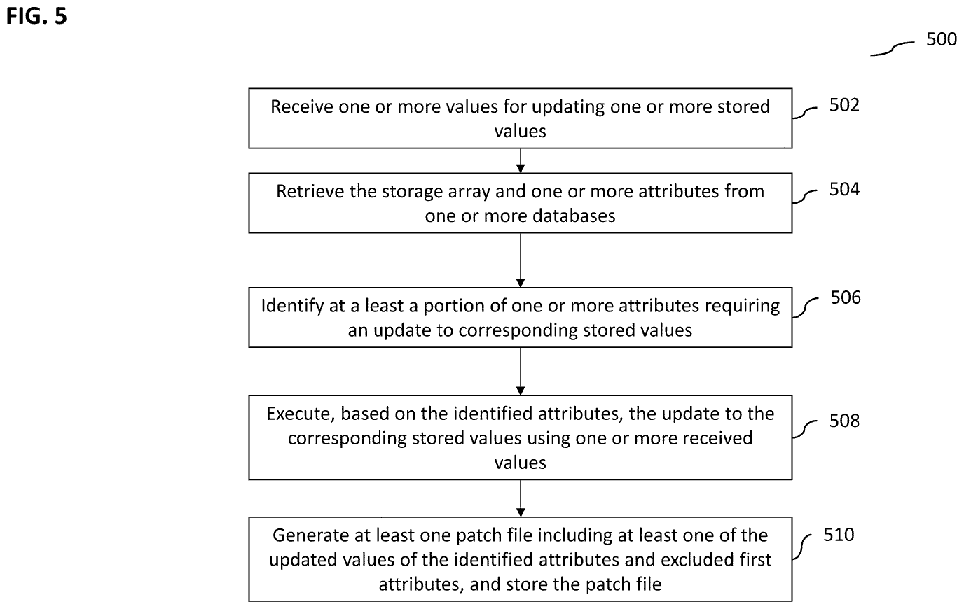

FIG. 5 illustrates an exemplary method 500 for executing a patch implementation to update one or more values stored by a target computing system, according to some implementations of the current subject matter. The method 500 may be executed using system 100 shown in FIGS. 1a-b using processes shown in FIGS. 2 and 3a-h.

At 502, at least one processor (e.g., engine 104) may receive one or more values for updating one or more stored values associated with one or more attributes of a storage array (e.g., arrays 308, 318, etc. as shown in FIGS. 3a-h). The arrays may be stored in one or more databases (e.g., persistent storage database 106) of a computing system.

At 504, the engine 104 may retrieve the storage array and one or more attributes from one or more databases. In particular, the engine 104 may retrieve the resources from the database 106 for the purposes of performing the patching update (e.g., adding, removal, etc., as shown in FIGS. 3a-h).

At 506, the engine 104 may be configured to identify at a least a portion of the one or more attributes requiring an update to corresponding stored values. Such attributes may be attributes that may be updated, rather than excluded (e.g., read-only, immutable, etc.).

At 508, the engine 104 may execute, based on the identified attributes, the update to the corresponding stored values using the received values. Some exemplary update processes are shown in FIGS. 3a-h, and may include addition of values or removal of values and/or attributes from the stored arrays. In some implementations, the update may exclude at least one first attribute in the identified attributes from the update. The first attributes may correspond to read-only and/or immutable attributes that cannot be removed/added and/or whose values cannot be altered and/or otherwise removed.

At 510, the engine 104 may be configured to generate at least one patch file that may include at least one of the updated values of the identified attributes and excluded first attributes. The patch file may be stored by the persistent storage database 106.

In some implementations, the current subject matter can include one or more of the following optional features. The update may include at least one of the following operations: an addition of a value operation, a removal of a value operation, an addition of an attribute to the storage array, a removal of an attribute from the storage array, and any combination thereof.

In some implementations, the excluded first attributes may include at least one of the following: a read-only attribute, an immutable attribute, and any combination thereof. Further, the receiving and/or any other operations 504-510 may be executed using a system cross-domain identity management (SCIM) protocol. The patch file may be a java script object notation (JSON) patch file. Further, the storage array may be a multi-value storage array that may include a plurality of attributes.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving, using at least one processor, one or more values for updating one or more stored values, the one or more stored values being associated with one or more attributes of a storage array stored in one or more databases of a computing system;
retrieving, using the at least one processor, the storage array and the one or more attributes from the one or more databases;
identifying, using the at least one processor, at a least a portion of the one or more attributes requiring an update to corresponding stored values;
executing, using the at least one processor, based on the identified attributes, the update to the corresponding stored values using the one or more received values, wherein the executing includes excluding, using the at least one processor, at least one first attribute in the identified one or more attributes from the update; and
generating, using the at least one processor, at least one patch file including at least one of the updated values of the identified attributes and excluded first attributes, and storing the at least one patch file.

2. The method according to claim 1, wherein the update includes at least one of the following operations: an addition of a value operation, a removal of a value operation, an addition of an attribute to the storage array, a removal of an attribute from the storage array, and any combination thereof.

3. The method according to claim 1, wherein the excluded first attributes include at least one of the following: a read-only attribute, an immutable attribute, and any combination thereof.

4. The method according to claim 1, wherein the receiving is executed using a system cross-domain identity management protocol.

5. The method according to claim 1, wherein the patch file is a java script object notation patch file.

6. The method according to claim 1, wherein the storage array is a multi-value storage array including a plurality of attributes.

7. A system comprising:
at least one programmable processor; and
a non-transitory machine-readable medium storing instructions that, when executed by the at least one programmable processor, cause the at least one programmable processor to perform operations comprising:
receiving, using at least one processor, one or more values for updating one or more stored values, the one or more stored values being associated with one or more attributes of a storage array stored in one or more databases of a computing system;
retrieving, using the at least one processor, the storage array and the one or more attributes from the one or more databases;
identifying, using the at least one processor, at a least a portion of the one or more attributes requiring an update to corresponding stored values;
executing, using the at least one processor, based on the identified attributes, the update to the corresponding stored values using the one or more received values, wherein the executing includes excluding, using the at least one processor, at least one first attribute in the identified one or more attributes from the update; and
generating, using the at least one processor, at least one patch file including at least one of the updated values of the identified attributes and excluded first attributes, and storing the at least one patch file.

8. The system according to claim 7, wherein the update includes at least one of the following operations: an addition of a value operation, a removal of a value operation, an addition of an attribute to the storage array, a removal of an attribute from the storage array, and any combination thereof.

9. The system according to claim 7, wherein the excluded first attributes include at least one of the following: a read-only attribute, an immutable attribute, and any combination thereof.

10. The system according to claim 7, wherein the receiving is executed using a system cross-domain identity management protocol.

11. The system according to claim 7, wherein the patch file is a java script object notation patch file.

12. The system according to claim 7, wherein the storage array is a multi-value storage array including a plurality of attributes.

13. A computer program product comprising a non-transitory machine-readable medium storing instructions that, when executed by at least one programmable processor, cause the at least one programmable processor to perform operations comprising:
receiving, using at least one processor, one or more values for updating one or more stored values, the one or more stored values being associated with one or more attributes of a storage array stored in one or more databases of a computing system;
retrieving, using the at least one processor, the storage array and the one or more attributes from the one or more databases;
identifying, using the at least one processor, at a least a portion of the one or more attributes requiring an update to corresponding stored values;
executing, using the at least one processor, based on the identified attributes, the update to the corresponding stored values using the one or more received values, wherein the executing includes excluding, using the at least one processor, at least one first attribute in the identified one or more attributes from the update; and
generating, using the at least one processor, at least one patch file including at least one of the updated values of the identified attributes and excluded first attributes, and storing the at least one patch file.

14. The computer program product according to claim 13, wherein the update includes at least one of the following operations: an addition of a value operation, a removal of a value operation, an addition of an attribute to the storage array, a removal of an attribute from the storage array, and any combination thereof.

15. The computer program product according to claim 13, wherein the excluded first attributes include at least one of the following: a read-only attribute, an immutable attribute, and any combination thereof.

16. The computer program product according to claim 13, wherein the receiving is executed using a system cross-domain identity management protocol.

17. The computer program product according to claim 13, wherein the patch file is a java script object notation patch file.

18. The computer program product according to claim 13, wherein the storage array is a multi-value storage array including a plurality of attributes.
